(19) United States
(12) Patent Application Publication
(10) Pub. No.: US 2026/0313258 A1
(43) Pub. Date: Oct. 8, 2026

(54) METHOD AND SYSTEM FOR MULTI-EXPOSURE IMAGING IN EXTENDED-REALITY SYSTEM

(71) Applicant: Varjo Technologies Oy, Helsinki (FI)

(72) Inventors: Mikko Ollila, Tampere (FI); Ari Antti Erik Peuhkurinen, Helsinki (FI)

(73) Assignee: Varjo Technologies Oy, Helsinki (FI)

(21) Appl. No.: 19/171,550

(22) Filed: Apr. 7, 2025

(51) Int. Cl. H04N 25/50; G06T 5/60; G06T 5/77

(52) U.S. Cl. CPC H04N 25/50; G06T 5/60; G06T 5/77; G06T 2207/10144; G06T 2207/20084

(57) ABSTRACT

A method for multi-exposure imaging in an extended-reality (XR) system. The method includes: controlling at least one camera to capture a set of images by employing at least a first exposure (FE) and a second exposure (SE) during a readout cycle; processing a first image amongst the set, captured using the first exposure, for generating a video pass-through (VPT) image of a real-world environment, wherein the VPT image is to be utilised for generating an XR image; and processing a second image amongst the set, captured using the second exposure, for enabling at least one non-VPT XR functionality.

### TECHNICAL FIELD

The present disclosure relates to methods for multi-exposure imaging in extended-reality (XR) systems. The present disclosure also relates to systems for multi-exposure imaging in XR systems.

### BACKGROUND

Extended Reality (XR) systems, encompassing Virtual Reality (VR), Augmented Reality (AR), and Mixed Reality (MR), offer immersive and interactive experiences by blending physical and digital worlds. These systems rely on advanced hardware, such as headsets, cameras, and sensors, and software to render virtual or augmented content in real-time. While the XR systems have found applications in entertainment, education, healthcare, and industrial domains, they face significant challenges in achieving seamless integration of virtual and real-world elements.

However, existing XR systems are associated with several limitations. Some existing XR systems are inefficient in terms of performing accurate segmentation of moving objects, where even minor errors in boundaries between virtual objects and real-world objects can disrupt a viewing experience of a user using an XR system. In such XR systems, accurate tracking and segmentation of user's hands are critical for ensuring seamless interaction between virtual objects and real-world objects. However, a common challenge arises when the user's hands are positioned close to a camera of the XR system. In such scenarios, the camera captures excessive illumination due to a high amount of returning light energy. This issue is particularly pronounced when the XR system employs an indirect Time-of-Flight (iTOF) sensor for depth sensing. A proximity of the user's hands to the iTOF sensor causes a significant amount of light to reflect back into a camera lens of the camera, resulting in glare. This glare causes the user's fingers to appear thicker than they actually are, a phenomenon commonly referred to as “fat fingers”. This issue disrupts accurate differentiation between virtual objects, real objects, and the user's hands, thereby reducing a precision of hand tracking and occlusion handling in such XR systems. Additionally, such XR systems often rely on employing separate cameras for different functionalities such as segmentation, depth sensing, gesture detection, motion tracking, and the like. This significantly increases processing complexity and an overall implementation cost and size of such XR systems. Moreover, reprojection challenges also arise when image data from the separate cameras are projected onto Video Pass-Through (VPT) feed. This leads to inaccuracies and misalignments that can be particularly noticeable in high-resolution XR systems. Furthermore, high computational demands of said functionalities make it difficult to integrate these into a single system without compromising its performance.

Therefore, in light of the foregoing discussion, there exists a need to overcome the aforementioned drawbacks.

### SUMMARY

The present disclosure seeks to provide a method and a system for multi-exposure imaging in an extended-reality (XR) system. The aim of the present disclosure is achieved by a method and a system which incorporate capturing and processing of at least a first image and a second image using different exposures, for enabling video pass-through (VPT) imaging and non-VPT XR functionalities. Due to this, a viewing experience of a user using an XR device is greatly improved, whilst reducing processing complexity and cost, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 illustrates steps of a method for multi-exposure imaging in an extended-reality (XR) system, in accordance with an embodiment of the present disclosure;

FIG. 2 illustrates a real-world environment in which a system for multi-exposure imaging in an extended-reality (XR) system is employed, in accordance with an embodiment of the present disclosure;

FIG. 3 illustrates an exemplary simplified process flow in a system for multi-exposure imaging in an extended-reality (XR) system, in accordance with an embodiment of the present disclosure;

FIGS. 4A and 4B illustrate an exemplary scenario for enabling a non-video pass-through (VPT) extended-reality (XR) functionality, in accordance with an embodiment of the present disclosure;

FIG. 5 illustrates an exemplary scenario for enabling another non-video pass-through (VPT) extended-reality (XR) functionality, in accordance with an embodiment of the present disclosure; and

FIG. 6 illustrates an exemplary scenario for enabling yet another non-video pass-through (VPT) extended-reality (XR) functionality, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognise that other embodiments for carrying out or practising the present disclosure are also possible.

In a first aspect, an embodiment of the present disclosure provides a method for multi-exposure imaging in an extended-reality (XR) system, the method comprising:
controlling at least one camera to capture a set of images by employing at least a first exposure and a second exposure during a readout cycle;
processing a first image amongst the set, captured using the first exposure, for generating a video pass-through (VPT) image of a real-world environment, wherein the VPT image is to be utilised for generating an XR image; and
processing a second image amongst the set, captured using the second exposure, for enabling at least one non-VPT XR functionality.

In a second aspect, an embodiment of the present disclosure provides a system for multi-exposure imaging in an extended-reality (XR) system, the system comprising:
at least one camera arranged on an XR device, wherein the at least one camera faces a real-world environment where the XR device is present; and
a processor coupled to the at least one camera, wherein the processor is configured to:
   control the at least one camera to capture a set of images by employing at least a first exposure and a second exposure during a readout cycle;
   process a first image amongst the set, captured using the first exposure, for generating a video pass-through (VPT) image of the real-world environment, wherein the VPT image is to be utilised for generating an XR image; and
   process a second image amongst the set, captured using the second exposure, for enabling at least one non-VPT XR functionality.

The present disclosure provides the aforementioned method and the aforementioned system that provide technical benefit in addressing challenges faced by existing XR systems. By utilising a same imaging device (namely, the at least one camera) for capturing multi-exposure image data, the method and the system enable accurate segmentation of moving objects in real-time. This eliminates errors in boundary detection between virtual objects and real-world objects, thereby ensuring a seamless and immersive viewing experience for the user. The method and the system further reduce a need for employing separate cameras for enabling non-VPT XR functionalities, for example, such as segmentation, depth sensing, gesture detection, motion tracking, and the like. This is achieved by leveraging the first image and the second image captured by the at least one camera using different exposure settings, which are processed to extract required information for these enabling such functionalities. Consequently, need for reprojection, processing complexity, implementation cost, and an overall size of the XR system are significantly reduced. By capturing at least two images (namely, at least the first image and the second image) at different exposures, the method and the system are susceptible to be used for both Video Pass-Through (VPT) XR imaging and non-VPT XR imaging. For example, the first exposure is selected to capture a bright and detailed image, ensuring that the VPT image provides a realistic and immersive view of the real-world environment; whereas the second exposure is selected for enabling the non-VPT XR functionalities such as motion tracking, depth sensing, and object detection, enhancing the XR system's capabilities, and providing enhanced user experiences. The system and the method are simple, robust, fast, reliable, supports real time multi-exposure imaging in XR systems, and can be implemented with ease.

Throughout the present disclosure, the term “multi-exposure imaging” refers to capturing of images by using different exposures. In this regard, a given image is captured by using a given exposure (namely, a given exposure setting). This means that the given image is captured using a combination of values of an exposure time, a sensitivity (ISO), and an aperture size. Hence, a value of the given exposure changes with a change in a value of at least one of: the exposure time, the sensitivity, the aperture size. The exposure time, the sensitivity, and the aperture size are well-known in the art. It will be appreciated that a same exposure can be achieved by employing multiple combinations of the values of the exposure time, the sensitivity, and the aperture size. As an example, an exposure having an exposure value of 10 may be achieved by employing any one of: (i) an exposure time of 1/30 second, a sensitivity of ISO 100, and an aperture size of f/4, (ii) an exposure time of 1/120 second, a sensitivity of ISO 400, and an aperture size of f/4. As another example, an exposure having an exposure value of 16 may be achieved by employing any one of: (i) an exposure time of 1/100 second, a sensitivity of ISO 100, and an aperture size of f/16, (ii) an exposure time of 1/200 second, a sensitivity of ISO 100, and an aperture size of f/11. Pursuant to embodiments of the present disclosure, the term “multi-exposure imaging” encompasses both capturing of images and processing of said images to produce further outputs (for example, such as generating corresponding XR images). The term “given image” encompasses at least the first image and the second image.

For illustration purposes, there will now be described how various components of the aforementioned system can be implemented. Throughout the present disclosure, the term “extended-reality system” refers to a specialised system that is configured to present an XR environment to a user when the XR system is in use. Optionally, the XR system comprises the XR device. Alternatively, optionally, the XR system comprises the XR device that is communicably coupled to a computing device. The term “extended-reality device” refers to a specialised device that is configured to display XR images. Optionally, the XR device is implemented as a head-mounted display (HMD) device that, in operation, is worn by the user on his/her head. In this regard, the HMD device acts as a specialised device (for example, such as an XR headset, a pair of XR glasses, and the like) that is operable to present a visual scene of the XR environment to the user. Examples of the computing device include, but are not limited to, a laptop, a desktop, a tablet, a phablet, a personal digital assistant, a workstation, and a console. The term “extended-reality” encompasses virtual reality (VR), augmented reality (AR), mixed reality (MR), and the like.

The processor controls an overall operation of the system. The processor is communicably coupled to the at least one camera. In some implementations, the processor is implemented as a processor of the XR device. In other implementations, the processor is implemented as a processor of the computing device. In yet other implementations, the processor is implemented as a cloud server (namely, a remote server) that provides a cloud computing service.

Optionally, the at least one camera comprises at least one visible-light camera. Examples of such a visible-light camera include, but are not limited to, a Red-Green-Blue (RGB) camera, a Red-Green-Blue-Alpha (RGB-A) camera, a Red-Green-Blue-Depth (RGB-D) camera, a Red-Green-Blue-White (RGBW) camera, a Red-Yellow-Yellow-Blue (RYYB) camera, a Red-Green-Green-Blue (RGGB) camera, a Red-Clear-Clear-Blue (RCCB) camera, a Red-Green-Blue-Infrared (RGB-IR) camera, and a monochrome camera. Additionally, optionally, the at least one camera further comprises at least one depth camera. Examples of such a depth camera include, but are not limited to, a Time-of-Flight (ToF) camera, a light detection and ranging (LiDAR) camera, a Red-Green-Blue-Depth (RGB-D) camera, a laser rangefinder, a stereo camera, a plenoptic camera, a ranging camera, a Sound Navigation and Ranging (SONAR) camera. All the aforementioned types of cameras are well-known in the art.

Optionally, an image sensor of the at least one camera has multi-exposure capture capability, the image sensor being one of: a global shutter image sensor, a rolling shutter image sensor operating in a staggered-exposure mode or a line-by-line exposure mode. In this regard, the multi-exposure capture capability enables the at least one camera to capture the set of images using different exposures during the readout cycle. The term “image sensor” refers to a device that detects light from the real-world environment at its photosensitive surface, thereby enabling a plurality of photo-sensitive cells arranged on the photo-sensitive surface to capture a plurality of image signals. The plurality of image signals are electrical signals pertaining to a real-world scene of the real-world environment. The plurality of image signals constitute image data of the plurality of photo-sensitive cells. Herein, the term “image data” refers to information pertaining to a given photo-sensitive cell arranged on the photosensitive surface of the image sensor, wherein said information comprises one or more of: a colour value of the given photo-sensitive cell, a depth value of the given photo-sensitive cell, a transparency value of the given photo-sensitive cell, a luminance value of the given photo-sensitive cell. The colour value could, for example, be Red-Green-Blue (RGB) values, Red-Green-Blue-Alpha (RGB-A) values, Cyan-Magenta-Yellow-Black (CMYK) values, Red-Green-Blue-Depth (RGB-D) values, or similar. Image sensors are well-known in the art. Examples of the image sensor include, but are not limited to, a charge-coupled device (CCD) image sensor, and a complementary metal-oxide-semiconductor (CMOS) image sensor.

It will be appreciated that the global shutter image sensor captures image data for an entirety of an image at once, ensuring that all the photo-sensitive cells are exposed simultaneously for detecting the light from the real-world environment. This is particularly useful for capturing dynamic object (namely, fast-moving objects) without any image artefacts such as blur or distortion. Furthermore, the rolling shutter image sensor with the staggered exposure mode captures an image by exposing different sets of lines of photo-sensitive cells at different times, overlapping their exposure periods. This allows said rolling shutter image sensor to use multiple exposures (such as a short exposure for motion detection and a long exposure for high dynamic range (HDR) imaging) when capturing a same image. On the other hand, the rolling shutter image sensor with the line-by-line exposure mode captures an image by exposing each line of the photo-sensitive cells sequentially rather than all at once, each line having a same exposure. This is a standard rolling shutter operation where an exposure starts and ends sequentially for each line of the photo-sensitive cells. For example, in low-light conditions, the at least one camera may be operated in the line-by-line exposure mode to capture images. The global shutter image sensor and the rolling shutter image sensor are well-known in the art.

Notably, during the readout cycle, the at least one camera captures the set of images using at least the first exposure and the second exposure. It will be appreciated that the at least one camera may also capture images using additional exposures (for example, such as a third exposure, a fourth exposure, and the like), in addition to using the first exposure and the second exposure. However, in a simplest implementation of the system, the at least one camera captures at least two images using at least two exposures, namely, the first image and the second image using the first exposure and the second exposure, respectively. Optionally, the set of images are received by the processor in a RAW data format, and wherein one or more processing steps of the method are performed in a RAW data domain. An image capturing operation using different exposures is well-known in the art. The term “readout cycle” refers to a process of reading out image data from an image sensor of the at least one camera to generate the set of images and communicate it to the processor.

It will be appreciated that the given image is a visual representation of the real-world environment. The term “visual representation” encompasses at least one of: colour information represented in the given image, depth information associated with the given image, luminance information (namely, brightness values) associated with the given image, transparency information (namely, alpha values) associated with the given image, polarisation information associated with the given image.

The first image is processed to generate the VPT image of the real-world environment. It will be appreciated that that the first exposure (using which the first image is captured) is selected by taking into account that it results in achieving high image quality (for example, in terms of a high resolution, a low noise, a high contrast, improved colour reproduction, and the like) in the first image. This is necessary because VPT imaging typically requires high image quality and improved dynamic range for realistic imaging, especially, in low-light conditions. In such a case, using a larger exposure can be beneficial to be used as the first exposure.

It will be appreciated that the VPT image represents a real-world scene of the real-world environment. Since the at least one camera is arranged on the XR device, it captures the first image from a perspective of a given eye of the user. Thus, the real-world scene presents a view of the real-world environment from a perspective of the given eye of the user. The real-world scene also represents real-world objects that lie in a field of view of the user. It is to be understood that when a stereo pair of cameras is employed, two first images are captured from a perspective of a first eye and a second eye of the user, respectively. The first eye is one of a left eye and a right eye of the user, while the second eye is another of the left eye and the right eye of the user.

Optionally, when generating the XR image, the processor is configured to digitally superimpose at least one virtual object on at least one region of the VPT image. The VPT image gets digitally modified when the at least one virtual object is digitally overlaid thereupon, to generate the XR image. The XR image could be one of: an AR image, an MR image. Optionally, when generating the XR image, the processor is configured to employ at least one image processing operation. Optionally, the at least one image processing operation is at least one of: a virtual object generation operation, an image colour-change operation, an image lighting-change operation, an image resizing operation, an image rotating operation, an object removal operation, an object occlusion operation, a geometrical distortion operation, an image blurring operation, an image sharpening operation, a night vision simulation operation, a denoising operation, a noise addition operation. Such image processing operations are well-known in the art. Upon generating the XR image, the XR image is displayed at the XR device. It will be appreciated that the XR image represents a region of the XR environment from a perspective of a viewpoint of the user. The XR image frame may pertain to an XR game, an XR tutorial, an XR instructional simulator, an XR movie, an XR educational video, or the like.

Herein, the term “virtual object” refers to a computer-generated object (namely, a digital content). Examples of the at least one virtual object may include, but are not limited to, a virtual navigation tool (such as a virtual map, a virtual direction signage, and so forth), a virtual gadget (such as a virtual calculator, a virtual computer, and so forth), a virtual message (such as a virtual instant message, a virtual to-do note, and so forth), a virtual entity (such as a virtual person, a virtual mascot, a virtual animal, a virtual ghost, and so forth), a virtual logo of a company, a virtual entertainment media (such as a virtual painting, a virtual video, a virtual advertisement, and so forth), a virtual vehicle or part thereof (such as a virtual car, a virtual cockpit, and so forth), and a virtual information (such as a virtual notification, a virtual news description, a virtual announcement, virtual data, and so forth).

Optionally, the step of processing the first image comprises at least one of:
applying a hallucination technique on the first image using a first neural network, for increasing an exposure of the first image from the first exposure to a target exposure;
applying an inpainting technique on the first image using a second neural network, for generating image data corresponding to missing or masked regions of the first image.

In this regard, the term “hallucination technique” refers to an image processing technique used for generating an image having a target exposure, when the image processing technique is applied to a corresponding image having an exposure and being captured using the at least one camera. It is noteworthy that the first image having the target exposure could be understood as a first hallucinated image because it is synthetically generated upon applying the hallucination technique, rather than being directly captured by the processor. The term “target exposure” refers to an exposure of an image after the hallucination technique has been applied on the image. It will be appreciated that since the exposure of the first image is increased from the first exposure to the target exposure, the target exposure is greater than the exposure of the first image. In this regard, the first image can be understood to be captured as a dark image, and the first hallucinated image (generated upon applying the hallucination technique on the first image) having the target exposure can be understood to be generated as a bright image. A technical benefit of applying the hallucination technique is that when the first image is captured dark, applying the hallucination technique enables in increasing the exposure of the first image as it is to be utilised for generating the VPT image and subsequently the XR image, and thus should have high image quality and improved dynamic range. It will be appreciated that the hallucination technique used on the first image is an advanced image enhancement technique, where the first neural network is utilised to predict areas of the first image that are underexposed, and then increase brightness for said areas of the first image. It will also be appreciated that the first neural network may be pre-trained using a large dataset of paired images, wherein each pair comprises a ground-truth image and a corresponding underexposed image.

Furthermore, the term “inpainting technique” refers to an image processing operation used to restore or reconstruct missing or corrupted parts of an image. It will be appreciated that the inpainting technique used on the first image is also an advanced image enhancement method, where the second neural network is utilised for reconstructing missing or corrupted parts of the first image. For example, when a region of the first image is obscured (for example, by a glare, a shadows, or a sensor noise), the inpainting technique can be used to reconstruct said region of the first image. A technical benefit of applying the inpainting technique is that it ensures that VPT image that is generated from the first image is visually consistent, i.e., the first image has complete visual information to be presented to the user, especially in cases where the first image has any missing or masked regions. It will be appreciated that an inpainting process typically involves reconstructing damaged, missing, or un-read image data (namely, pixel values) of some pixels by using image data that is available from other neighbouring pixels. The inpainting process and algorithms/technique for inpainting using the second neural network are well-known in the art. It will also be appreciated that the second neural network may be pre-trained using a large dataset of paired images, wherein each pair comprises a ground-truth image and a corresponding image having missing or masked region(s).

Optionally, a given neural network is any one of: a recurrent neural network (RNN), a U-net type neural network, an autoencoder, a pure Convolutional Neural Network (CNN), a Residual Neural Network (ResNet), a Vision Transformer (VIT), a neural network having self-attention layers, a diffusion neural network, a generative adversarial network (GAN). All the aforesaid types of neural networks are well-known in the art. The term “given neural network” encompasses the first neural network and/or the second neural network. Optionally, the first neural network and the second neural network are integrated into a single neural network. This integration of two separate neural networks into a single, unified neural network streamlines processing pipeline for the processor by enabling both tasks (namely, increasing the exposure and generating missing/obliterated image data) to be performed simultaneously.

Notably, the second image that is captured using the second exposure, is processed to enable the at least one non-VPT XR functionality. Throughout the present disclosure, the term “non-video pass-through XR functionality” refer to a feature that do not directly contribute to the generation of the VPT image but is essential for enabling advanced XR capabilities. In other words, a given non-VPT XR functionality is based on processing of the second image captured using an exposure setting that is optimised for performing a particular task, for example, such as motion tracking, depth sensing, object detection, or similar, without compromising on a visual quality of the VPT image. A purpose of the at least one non-VPT XR functionality is to provide additional data and capabilities that enhance the XR system's ability to interact with and understand the real-world environment, thereby improving an overall viewing experience of the user in the XR environment. The at least one non-VPT XR functionality complements the XR image by enabling the XR system to perform said particular task. By dedicating the second image to these tasks, the XR system achieves a high degree of accuracy, efficiency, and adaptability.

It will be appreciated that when processing the second image, the processor is configured to analyse the second image to extract specific image data required for enabling the at least one non-VPT XR functionality. Such an extraction process depends on a type of a given non-VPT XR functionality being implemented. In an example, for enabling a motion tracking functionality, the processor may compare the second image with previous images to calculate motion vectors, which represent a direction and a speed of movement of object(s) represented in the second image. In another example, for enabling a depth sensing functionality, the processor may process the second image to calculate optical depths of objects from the at least one camera, for creating a depth map. In yet another example, for enabling a gesture detection functionality, the processor may analyse the second image to identify patterns or shapes corresponding to specific gestures. In still another example, for enabling a background segmentation functionality, the processor may perform image processing operation to separate a foreground (for example, a user's body part in the second image or an object of interest) from a background in the second image.

It is noteworthy that the second exposure (using which the second image is captured) is tailored to requirements of the at least one non-VPT XR functionality. For example, a shorter exposure minimises a motion blur, thereby making the second image usable for detecting fast-moving objects or changes in a visual scene. Similarly, the second exposure can be adjusted to enhance contrast or capture specific wavelengths of light (for example, infrared wavelengths) for enabling non-VPT XR functionalities such as a depth sensing functionality or a background segmentation non-VPT XR functionality. A technical benefit of capturing the second image during the same readout cycle as the first image, the XR system maximises the use of the image sensor's capabilities, as this eliminates a need for additional cameras or sensors, reducing an overall cost, size, and complexity of the system. An ability to employ multiple exposures using a same camera also minimises latency, ensuring real-time performance in XR applications.

Optionally, the at least one non-VPT XR functionality comprises at least one of: differential image generation, motion vector processing or generation, background segmentation, infrared (IR) imaging, depth sensing, rolling shutter removal, object detection, activity detection, gesture detection.

When the given non-VPT XR functionality is the differential image generation, the processor can be configured to compare the second image with a previously-captured image (i.e., the first image or another second image from a prior readout cycle) to determine a pixel intensity differences between the second image and the previously-captured image to generate a differential image. The differential image is indicative of changes in a visual scene, such as a motion of an object or object displacement, while suppressing static regions in the real-world environment. The differential image generation can be used to detect changes in the real-world environment, such as the movement of objects or users. As an example, in the XR system, the differential image generation detects any hand movements or gestures of the user by comparing two images with different exposures. This helps in giving input for the generation of the second image and finally results into the better XR image and experience to user.

When the given non-VPT XR functionality is the motion vector processing or generation, the processor can compare the second image with at least one previously-captured image (for example, the first image or another second image from a prior readout cycle) to detect changes in pixel positions, pixels representing objects to calculate at least one motion vector that represent a direction and a speed of movement for each region (corresponding to a given object or its part) in the second image. A set of motion vectors describe a movement of object or a user or user's body part in the visual scene. The motion vector processing or generation enable motion tracking and interaction with virtual elements in the XR system. For example, the motion vector processing may track the movement of user's hand based on magnitude and direction of a corresponding motion vector in order to control user experience.

When the given non-VPT XR functionality is the background segmentation, the processor can process the second image to separate a foreground of the second image (for example, a user's body part or an object of interest in the real-world environment) from a background of the second image. Some well-known techniques such as contrast analysis or differential imaging could be used to isolate the foreground. The background segmentation can be employed to enable functionalities such as virtual background replacement or object isolation. The term “background segmentation” refers to a process of separating a foreground from a background in a given image. For example, in the XR system, the background segmentation can be employed to isolate user's hand for gesture recognition while ignoring static background.

When the given non-VPT XR functionality is the IR imaging and/or the depth sensing, the second image is captured using an IR-sensitive sensor (or another form of a depth sensor) using the second exposure. In such a case, the at least one camera comprises an IR camera. The processor processes IR image data of the second to enhance visibility in low-light conditions or detect heat signatures. The IR imaging results in generating an IR image or a heat map that highlights objects or regions of interest, to enable functionalities like night vision or thermal imaging in XR applications. The IR imaging is primarily used for depth sensing, where the IR light emitter emits IR light and measures the time it takes to reflect back from objects (time-of-flight) or analyses the distortion of a projected IR pattern (structured light). The captured IR data is processed to calculate the distance of objects from the camera, enabling accurate depth maps. These depth maps are crucial for applications like hand tracking, gesture recognition, and environmental mapping in XR systems, as they allow the system to understand spatial relationships between objects in the real world environment. By integrating IR imaging and/or the depth sensing with multi-exposure techniques, the at least one camera performs both RGB imaging for VPT and depth sensing for non-VPT functionalities, reducing hardware complexity and improving reprojection accuracy.

When the given non-VPT XR functionality is the rolling shutter removal, the processor can identify distortions in the second image caused by the rolling shutter effect. In this regard, the processor may apply some well-known algorithms to correct artifacts such as skewing or wobbling in the second image. Upon performing the rolling shutter removal, a corrected image free of rolling shutter distortions is generated. Typically, the rolling shutter image sensor operating in staggered-exposure mode still reads out pixel lines sequentially which can introduce rolling shutter artifacts, such as motion distortion, where fast-moving objects appear skewed due to different rows capturing different time points. Another issue is the wobble or “jello effect”, where vibrations cause wavy distortions in the image. Additionally, flash banding can occur when a scene is illuminated by a flickering light source, leading to uneven lighting across the frame. To address these artifacts, the rolling shutter removal is performed to reconstruct a distortion-free image, making it appear as if it were captured with a global shutter.

When the given non-VPT XR functionality is the object detection, the processor can process the second image by utilising a machine learning algorithm or a pre-trained neural network to identify a plurality of features in the second image. The plurality of features comprises at least one of: edges, corners, blobs, ridges, shapes, and textures. The processor then compare these features with a database of known objects. It will be appreciated that for the object detection, the processor may also employ at least one object detection algorithm. Such object detection algorithms are well-known in the art.

When the given non-VPT XR functionality is the activity detection, the processor can process the second image to identify patterns or movements that correspond to pre-defined activities. This is achieved by applying machine learning models or algorithms that analyse spatial and temporal features of the image. For example, the processor may detect changes in posture, limb movement, or overall body orientation to classify activities such as walking, running, sitting, or jumping. An output of this processing is a recognised activity, which can be used to trigger specific responses or interactions in the XR system. For instance, in an XR fitness application, the system can detect when a user performs a squat or a push-up and provide real-time feedback on their form. By leveraging the second image for activity detection, the XR system enables dynamic and context-aware interactions, enhancing the user experience.

When the given non-VPT XR functionality is the gesture detection, the processor can detect patterns or shapes that correspond to pre-defined gestures (such as pointing, waving, pinching, or forming a fist). It will be appreciated that some key points, for example, such as positions of fingers, hands, or arms, are identified and tracked using image processing techniques or machine learning models. An output of this processing is a recognised gesture, such as a swipe, pinch, or pointing motion. These gestures can then be used to control virtual objects, navigate menus, or perform other interactive tasks in the XR environment. For example, in an XR control system, a swiping gesture can be used to scroll through a virtual interface, while a pointing gesture can select an object. By enabling gesture detection through the second image, the XR system provides an intuitive and natural way for users to interact with virtual elements, enhancing immersion and usability.

A technical benefit of enabling non-VPT XR functionalities in the XR system is that a versatility and interactivity of the system is improved, by providing advanced capabilities such as motion tracking, depth sensing, gesture detection, and background segmentation. These functionalities allow the XR system to accurately understand and interact with the real-world environment, enabling seamless integration of virtual elements, improving user immersion, and supporting real-time, context-aware interactions, all while optimising resource utilisation by leveraging the same image sensor for both VPT and non-VPT tasks. This reduces the need for additional hardware, and saves cost and space.

Optionally, the at least one camera is controlled to capture the set of images by further employing at least one additional exposure during the readout cycle, and wherein the method further comprises processing at least one additional image of the set, captured using the at least one additional exposure, for enabling the at least one non-VPT XR functionality. In this regard, in addition to the first exposure and the second exposure, the at least one camera captures the at least one additional image using the at least one additional exposure. The at least one additional exposure can be derived from dividing a long exposure into multiple, individual short exposures (for example, five short exposures). For example, in the XR system, the first exposure may be used for generating a high-quality RGB VPT image, and the second exposure may be used for capturing fast-moving objects like hand gestures. It will be appreciated that by capturing the at least one additional exposure, the XR system can support complex non-VPT XR functionalities, such as differential image generation, motion tracking, or depth sensing, with higher accuracy and detail. This is because the at least one additional exposure allow the system to gather more information from the real-world environment, improving precision and reliability of non-VPT XR tasks. In an example, the at least one additional exposure can be used for advanced imaging techniques, such as HDR (High Dynamic Range) imaging, which enhances a visual quality of the VPT image while simultaneously supporting non-VPT XR functionalities. In traditional HDR imaging, a long exposure is used to capture bright and dark areas of a scene. However, when the long exposure is divided into multiple shorter exposures (such as 5 exposures), these shorter exposures can serve as additional exposures for enabling non-VPT XR functionalities, such as motion tracking, differential image generation, or depth sensing. For instance, while one exposure is used for generating the VPT image, the remaining exposures can be processed to detect motion, calculate depth, or perform background segmentation. In this way, the XR system can repurpose the exposure time typically allocated for HDR imaging to perform multiple tasks simultaneously, enhancing the system's overall functionality and efficiency.

Optionally, the at least one camera is controlled to alternate between at least the first exposure and the second exposure during successive readout cycles. In this regard, the first image and the second image are captured by using the first exposure and the second exposure in an alternating manner during the successive readout cycles. For example, in a first readout cycle, the first image may be captured using the first exposure whereas the second image may be captured using the second exposure; in a second readout cycle, the first image may be captured using the second exposure whereas the second image may be captured using the first exposure; in a third readout cycle, the first image may be captured using the first exposure whereas the second image may be captured using the second exposure; and so on. In a case where at least one additional exposure is also used for capturing the at least one additional image, then the at least one additional exposure would also become part of such an alternating sequence (in addition to at least the first exposure and the second exposure).

A technical benefit of alternating between at least the first exposure and the second exposure during the successive readout cycles is to prevent perceptible artifacts or inconsistencies in a sequence of XR images generated from a corresponding sequence of first images. If the same exposure is consistently used for capturing the first image in every readout cycle, the resulting XR images may exhibit repetitive patterns or artifacts that could be noticeable to the user. This could reduce the realism and immersiveness of the XR experience, as the user may perceive a lack of natural variation in the displayed images. Alternating the exposures ensures that the sequence of XR images generated from the corresponding sequence first images does not exhibit repetitive patterns or artifacts. This creates a more natural and seamless viewing experience for the user. Any minor differences or artifacts introduced by the exposure settings are distributed across the sequence of XR images, making them less noticeable to the user. This improves the overall visual quality and realism of the XR experience. The alternating exposures ensure that the XR images appear dynamic and lifelike, enhancing the user's sense of presence and immersion in the virtual environment. Additionally, some non-VPT XR functionalities may benefit from the second image captured under different exposure settings. For example, a longer exposure may capture more detail in low-light conditions, improving depth sensing. A shorter exposure may reduce motion blur, improving motion tracking and gesture detection. Alternating exposures ensures that the system collects complementary data for different non-VPT XR tasks, enhancing their accuracy and robustness. Moreover, alternating exposures may ensure that the second image captures data under varying conditions, reducing a risk of temporal inconsistencies in some non-VPT XR functionalities. For example, in motion tracking or activity detection, consistent and diverse data is critical for maintaining accuracy over time. Alternating exposures helps achieve this by providing a balanced dataset.

Optionally, the second exposure is lesser than the first exposure. In this regard, the first image is captured using an exposure that is greater than an exposure using which the second image is captured. A technical benefit of this is that since VPT imaging typically requires high image quality, the (larger) first exposure is used for capturing the first image (using which the VPT image is generated subsequently) as it enables better image quality in low-light conditions, reduced noise in the first image, and improved dynamic range for realistic imaging. On the other hand, non-VPT XR functionalities require high temporal resolution, reduced motion blur, precise timing, and the like, and thus the (smaller) second exposure is used for capturing the second image (that is processed for enabling the at least one non-VPT XR functionality) as it minimises motion blur, allows for faster frame capture, reduces overexposure in bright areas, and the like.

Optionally, the method further comprises receiving information indicative of the at least one non-VPT XR functionality that is required to be implemented by the XR system, wherein the step of controlling the at least one camera comprises decoupling exposure durations of the first exposure and the second exposure, based on the received information.

Optionally, in this regard, the processor is configured to receive said information from at least one of:
an XR app which generates an XR environment;
a data repository at which user preferences which may be pre-stored;
the XR device or an accessory of the XR device or a computing device associated with the XR device;
a data repository at which default non-VPT XR functionalities associated with the XR device are pre-stored.

It will be appreciated that the user preferences can be obtained when the user starts an XR viewing session/starts an XR application. Decoupling of the exposure durations of the first exposure and the second exposure allows the XR system to independently control the exposure durations of the first and second exposures, ensuring that each exposure can utilised for its intended purpose. For example, the first exposure can be set to a longer duration to capture a bright and detailed first image for generating the VPT image, while the second exposure can be set to a shorter duration to capture a sharp and motion-blur-free second image for enabling non-VPT XR functionalities such as motion tracking, depth sensing, or gesture detection. This flexibility ensures that the XR system can adapt to varying application requirements and environmental conditions. In an example, the XR application generating the XR environment can provide information about required non-VPT XR functionalities. For example, an XR gaming app may prioritise motion tracking and gesture detection, prompting the system to adjust the second exposure accordingly. In another example, the user preferences can influence the exposure durations in a case where a user may prefer enhanced depth sensing for industrial applications or precise motion tracking for gaming. These preferences can be retrieved when the user starts the XR viewing session. In yet another example, an accessory of the XR device such as a motion controller may require improvement in motion tracking, prompting the system to adjust the second exposure (SE). Similarly, the XR device designed for low-light environments may prioritise infrared imaging and depth sensing.

In a typical exposure system, all exposures are tied together, meaning they have fixed durations or ratios. For example, when the first exposure is set to 10 milliseconds, the second exposure may always be half of that (5 milliseconds). Pursuant to embodiments of the present disclosure, when decoupling is employed, the durations of first exposure and second exposure become independently adjustable. This flexibility allows the system to allocate exposure times dynamically based on the task needed or has to perform. For example, in a situation where the HMD of the XR system needs to perform both hand tracking and VPT imaging. The processor receives information that hand tracking is a priority then adjusts the exposure of the at least one camera by shortening the second exposure to capture fast hand movements while maintaining a longer first exposure for generating a high-quality RGB image of the environment. This ensures accurate hand tracking without compromising the VPT feed. The decoupling exposure duration of the first exposure and the second exposure ensures that both functionalities (VPT and non-VPT) are optimised without interfering with each other. A technical benefit of such a dynamic decoupling of the exposure durations allows the XR system to optimise the first exposure and the second exposure (SE) for their respective tasks. Additionally, this also repurposes the camera's multi-exposure HDR capabilities for non-HDR applications, such as motion tracking, gesture detection, and background segmentation. This use of HDR technology enhances a versatility of the XR system.

The present disclosure also relates to the system as described above. Various embodiments and variants disclosed above, with respect to the aforementioned first aspect, apply mutatis mutandis to the system.

Optionally, in the system, the at least one non-VPT XR functionality comprises at least one of: differential image generation, motion vector processing or generation, background segmentation, infrared (IR) imaging, depth sensing, rolling shutter removal, object detection, activity detection, gesture detection.

Optionally, in the system, the processor is further configured to receive information indicative of the at least one non-VPT XR functionality that is required to be implemented by the XR system,
wherein when controlling the at least one camera, the processor is configured to decouple exposure durations of the first exposure and the second exposure, based on the received information.

Optionally, in the system, the at least one camera is controlled to capture the set of images by further employing at least one additional exposure during the readout cycle, wherein the processor is further configured to process at least one additional image of the set, captured using the at least one additional exposure, for enabling the at least one non-VPT XR functionality.

Optionally, in the system, the at least one camera is controlled to alternate between at least the first exposure and the second exposure during successive readout cycles.

Optionally, in the system, the second exposure is lesser than the first exposure.

Optionally, in the system, an image sensor of the at least one camera has multi-exposure capture capability, the image sensor being one of: a global shutter image sensor, a rolling shutter image sensor operating in a staggered-exposure mode or a line-by-line exposure mode.

Optionally, in the system, when processing the first image, the processor is configured to perform at least one of:
apply a hallucination technique on the first image using a first neural network, for increasing an exposure of the first image from the first exposure to a target exposure;
   apply an inpainting technique on the first image using a second neural network, for generating image data corresponding to missing or masked regions of the first image.

### DETAILED DESCRIPTION OF THE DRAWINGS

Referring to FIG. 1, illustrated are steps of a method for multi-exposure imaging in an extended-reality (XR) system, in accordance with an embodiment of the present disclosure. At step 102, at least one camera is controlled to capture a set of images by employing at least a first exposure and a second exposure during a readout cycle. At step 104, a first image amongst the set, captured using the first exposure, is processed for generating a video pass-through (VPT) image of a real-world environment, wherein the VPT image is to be utilised for generating an XR image. At step 106, a second image amongst the set, captured using the second exposure, is processed for enabling at least one non-VPT XR functionality.

The aforementioned steps are only illustrative and other alternatives can also be provided where one or more steps are added, one or more steps are removed, or one or more steps are provided in a different sequence without departing from the scope of the claims herein.

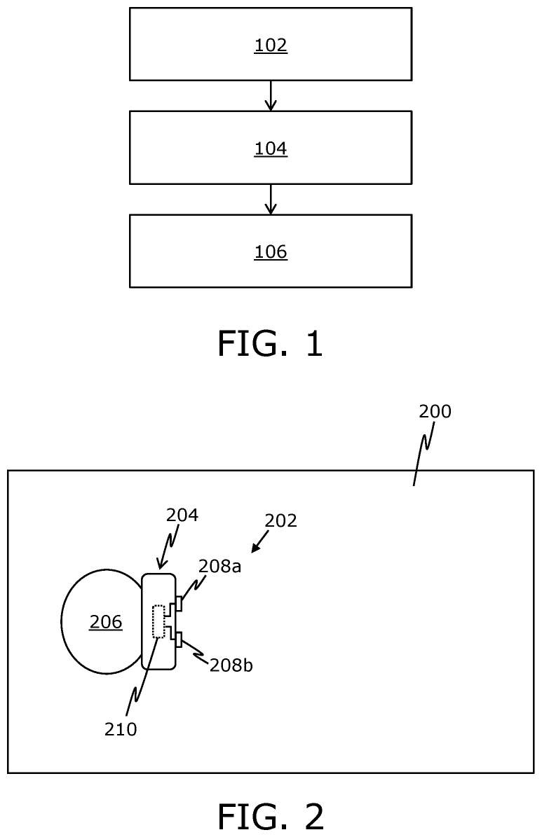

Referring to FIG. 2, illustrated is a real-world environment 200 in which a system 202 for multi-exposure imaging in an extended-reality (XR) system is employed, in accordance with an embodiment of the present disclosure. The system 202 is shown to be implemented, for example, inside an XR device 204. The XR device 204 is shown to be implemented, for example, as a head-mounted display (HMD) device that, in operation, is worn by a user on his/her head 206. For sake of simplicity and clarity, a top view of the real-world environment is depicted in FIG. 2. The system 202 comprises at least one camera (for example, depicted as two cameras 208a and 208b) and a processor 210. The two cameras 208a-b are arranged on the XR device 204 in a manner that the two cameras 208a-b face the real-world environment 200. The two cameras 208a-b are communicably coupled to the processor 210. The processor 210 is configured to implement the steps of the aforementioned method as described in FIG. 1.

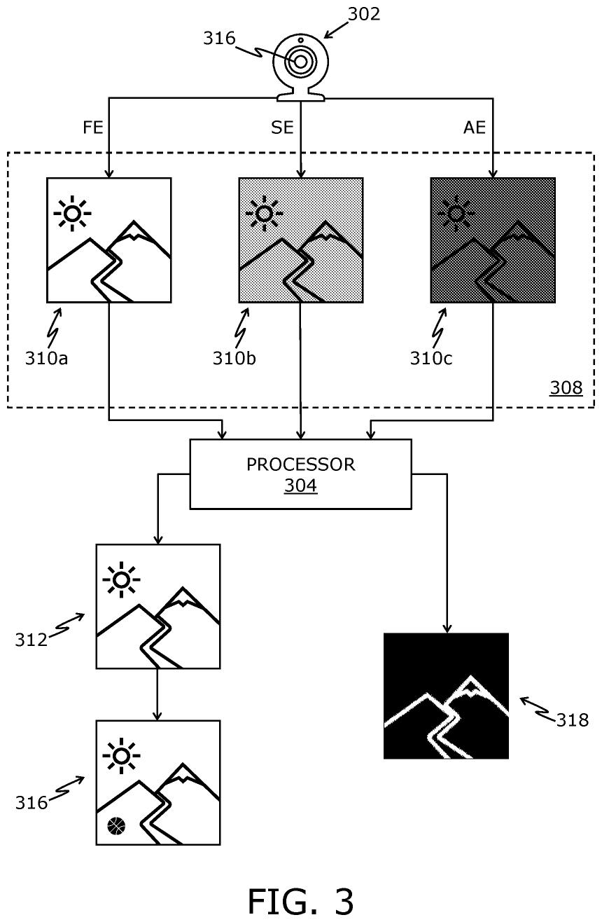

Referring to FIG. 3, illustrated is an exemplary simplified process flow in a system for multi-exposure imaging in an extended-reality (XR) system, in accordance with an embodiment of the present disclosure. The system comprises at least one camera (depicted as a camera 302) and a processor 304. Optionally, the camera 302 comprises an image sensor 306. The camera 302 is controlled to capture a set 308 of images by employing at least a first exposure FE and a second exposure SE during a readout cycle, wherein a first image 310a in the set 308 is captured using the first exposure FE, and a second image 310b in the set 308 is captured using the second exposure SE. Optionally, the camera 302 is controlled to capture an additional image 310c using an additional exposure AE during the readout cycle, wherein the set 308 also includes the additional image 310c. The processor 304 is configured to process the first image 310a to generate a video pass-through (VPT) image 312 of a real-world environment, wherein the VPT image 312 is utilised for generating an XR image 316. Subsequently, the processor 304 is configured to process the second image 310b and additionally optionally, the additional image 310c, to enable at least one non-VPT XR functionality 318. The at least one non-VPT XR functionality 318 comprises at least one of: differential image generation, motion vector processing or generation, background segmentation, infrared (IR) imaging, depth sensing, rolling shutter removal, object detection, activity detection, gesture detection.

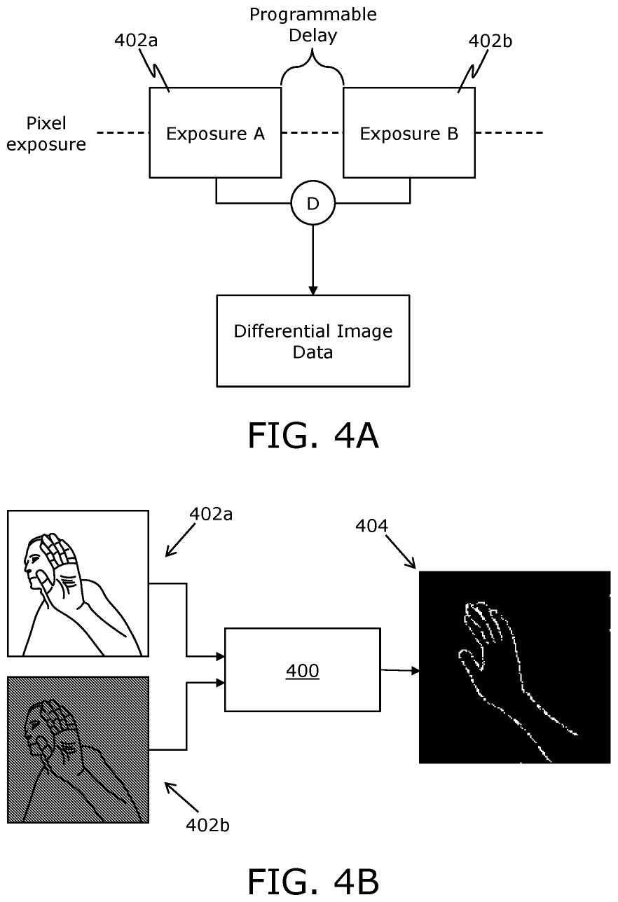

Referring to FIGS. 4A and 4B, FIGS. 4A and 4B illustrate an exemplary scenario for enabling a non-video pass-through (VPT) extended-reality (XR) functionality, in accordance with an embodiment of the present disclosure. The non-VPT XR functionality depicted in FIGS. 4A and 4B is, for example, differential image generation. With reference to FIG. 4A, there is depicted an exemplary process flow for enabling the differential image generation. A processor 400 (shown in subsequent FIG. 4B for sake of clarity only) is configured to control a camera (not shown) to capture a first image 402a using a first exposure (depicted as Exposure A), and a second image 402b using a second exposure (depicted as Exposure B). The first exposure and the second exposure are understood be exposures at a pixel level, i.e., a pixel exposure when capturing the first image 402a and the second image 402b. There is also shown a programmable delay between the first exposure and the second exposure. The programmable delay may be added because an image sensor of the camera would require some time to read out and store the first image (at the first exposure) before capturing the second image (at the second exposure). Further, the processor 400 is configured to employ a differential operator D to determine differential image data, by computing differences between image data captured in the first image and image data captured in the second image. The differential image data can then be used for the differential image generation. With reference to FIG. 4B, there are depicted exemplary illustrations of the first image 402a, the second image 402b, and a differential image 404 that is generated (by the processor 400) using the determined differential image data.

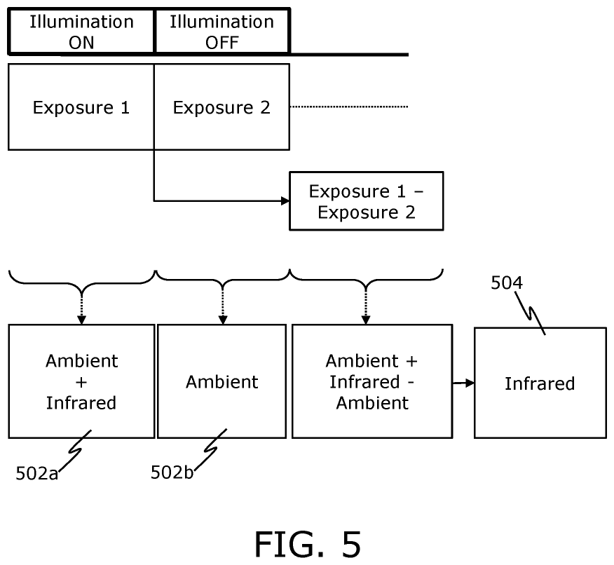

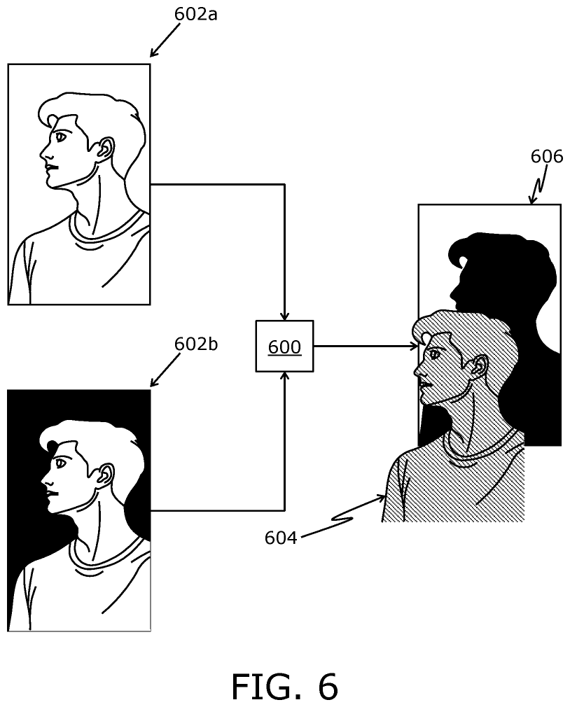

Referring to FIG. 5, illustrated is an exemplary scenario for enabling another non-video pass-through (VPT) extended-reality (XR) functionality, in accordance with an embodiment of the present disclosure. The another non-VPT XR functionality depicted in FIG. 5 is, for example, infrared (IR) imaging. There is depicted an exemplary process flow for enabling the IR imaging. A processor (not shown) is configured to control a camera (not shown) to capture a first image 502a using a first exposure (depicted as Exposure 1), and a second image 502b using a second exposure (depicted as Exposure 2). The first exposure is used with illumination “ON”, whereas and the second exposure is used with illumination “OFF”, and exposure values of both the first image and the second image are same; there is only difference of illumination. Thus, when capturing the first image, an image sensor of the camera captures both ambient light signals (namely, visible-light signals) and IR light signals. On the other hand, when capturing the second image, an image sensor of the camera captures only ambient light signals. Further, the processor is configured to employ a differential operator to determine differential image data for the IR imaging, by computing differences between image data captured in the first image and image data captured in the second image. The differential image data can then be used for generating an IR image 504.

Referring to FIG. 6, illustrated is an exemplary scenario for enabling yet another non-video pass-through (VPT) extended-reality (XR) functionality, in accordance with an embodiment of the present disclosure. The yet another non-VPT XR functionality depicted in FIG. 6 is, for example, background segmentation. Herein, a processor 600 is configured to obtain, from a camera (not shown), a first image 602a captured using a first exposure, and a second image 602b captured using a second exposure. Then, the processor 600 is configured to process the second image to separate a foreground (for example, depicted as a user's body) in the second image from a background (for example, depicted as a plain wall) in the second image, by utilising the first image.

FIGS. 2, 3, 4A, 4B, 5, and 6 are merely examples, which should not unduly limit the scope of the claims herein. The person skilled in the art will recognise many variations, alternatives, and modifications of embodiments of the present disclosure.

1. A method for multi-exposure imaging in an extended-reality (XR) system, the method comprising:
controlling at least one camera to capture a set of images by employing at least a first exposure and a second exposure during a readout cycle;
processing a first image amongst the set, captured using the first exposure, for generating a video pass-through (VPT) image of a real-world environment, wherein the VPT image is to be utilised for generating an XR image; and
processing a second image amongst the set, captured using the second exposure, for enabling at least one non-VPT XR functionality.

2. The method of claim 1, wherein the at least one non-VPT XR functionality comprises at least one of: differential image generation, motion vector processing or generation, background segmentation, infrared (IR) imaging, depth sensing, rolling shutter removal, object detection, activity detection, gesture detection.

3. The method of claim 1, further comprising receiving information indicative of the at least one non-VPT XR functionality that is required to be implemented by the XR system,
wherein the step of controlling the at least one camera comprises decoupling exposure durations of the first exposure and the second exposure, based on the received information.

4. The method of claim 1, wherein the at least one camera is controlled to capture the set of images by further employing at least one additional exposure during the readout cycle, and wherein the method further comprises processing at least one additional image of the set, captured using the at least one additional exposure, for enabling the at least one non-VPT XR functionality.

5. The method of claim 1, wherein the at least one camera is controlled to alternate between at least the first exposure and the second exposure during successive readout cycles.

6. The method of claim 1, wherein the second exposure is lesser than the first exposure.

7. The method of claim 1, wherein an image sensor of the at least one camera has multi-exposure capture capability, the image sensor being one of: a global shutter image sensor, a rolling shutter image sensor operating in a staggered-exposure mode or a line-by-line exposure mode.

8. The method of claim 1, wherein the step of processing the first image comprises at least one of:
applying a hallucination technique on the first image using a first neural network, for increasing an exposure of the first image from the first exposure to a target exposure;
applying an inpainting technique on the first image using a second neural network, for generating image data corresponding to missing or masked regions of the first image.

9. A system for multi-exposure imaging in an extended-reality (XR) system, the system comprising:
at least one camera arranged on an XR device, wherein the at least one camera faces a real-world environment where the XR device is present; and
a processor coupled to the at least one camera, wherein the processor is configured to:
control the at least one camera to capture a set of images by employing at least a first exposure and a second exposure during a readout cycle;
process a first image amongst the set, captured using the first exposure, for generating a video pass-through (VPT) image of the real-world environment, wherein the VPT image is to be utilised for generating an XR image; and
process a second image amongst the set, captured using the second exposure, for enabling at least one non-VPT XR functionality.

10. The system of claim 9, wherein the at least one non-VPT XR functionality comprises at least one of: differential image generation, motion vector processing or generation, background segmentation, infrared (IR) imaging, depth sensing, rolling shutter removal, object detection, activity detection, gesture detection.

11. The system of claim 9, wherein the processor is further configured to receive information indicative of the at least one non-VPT XR functionality that is required to be implemented by the XR system,
wherein when controlling the at least one camera, the processor is configured to decouple exposure durations of the first exposure and the second exposure, based on the received information.

12. The system of claim 9, wherein the at least one camera is controlled to capture the set of images by further employing at least one additional exposure during the readout cycle, and wherein the processor is further configured to process at least one additional image of the set, captured using the at least one additional exposure, for enabling the at least one non-VPT XR functionality.

13. The system of claim 9, wherein the at least one camera is controlled to alternate between at least the first exposure and the second exposure during successive readout cycles.

14. The system of claim 9, wherein an image sensor of the at least one camera has multi-exposure capture capability, the image sensor being one of: a global shutter image sensor, a rolling shutter image sensor operating in a staggered-exposure mode or a line-by-line exposure mode.

15. The system of claim 9, wherein when processing the first image, the processor is configured to perform at least one of:
apply a hallucination technique on the first image using a first neural network, for increasing an exposure of the first image from the first exposure to a target exposure;
apply an inpainting technique on the first image using a second neural network, for generating image data corresponding to missing or masked regions of the first image.
